(19) United States
(12) Patent Application Publication
(10) Pub. No.: US 2018/0158040 A1
(43) Pub. Date: Jun. 7, 2018

(54) SYSTEM AND METHOD FOR PROTECTING AT LEAST ONE ELEMENT OF AN UNATTENDED TRANSACTION TERMINAL

(71) Applicant: INGENICO GROUP, Paris (FR)

(72) Inventors: Stephane Pavageau, La Roche De Glun (FR); Roger Devornique, Valence (FR)

(21) Appl. No.: 15/829,213

(22) Filed: Dec. 1, 2017

(30) Foreign Application Priority Data
Dec. 1, 2016 (FR) 1661799

(51) Int. Cl. G06Q 20/20; G06Q 20/40

(52) U.S. Cl. CPC G06Q 20/20; G06Q 20/40

(57) ABSTRACT

A system is provided for protecting at least one element of an unattended transaction terminal, referred to as the element to be protected. The system includes features for protecting the element or elements to be protected, delivering at least one of interaction with at least one user of the unattended transaction terminal; and features for detecting an abnormality according to the interaction.

### FIELD OF THE INVENTION

The invention relates to the field of so-called unattended payment terminals, such as for example payment terminals for parking, for buying tickets for transport or show seats, drinks or snacks dispensers, etc., and banknote dispensers, also unattended.

More particularly, the invention relates to the protection of keypads and card readers of such devices, hereinafter referred to, for easier reading, as “unattended transaction terminals”.

### PRIOR ART

Currently, this type of unattended transaction terminal is the subject of a known attack consisting of depositing, by adhesive bonding, for example, on top of an existing keypad or card reader, a fake keypad/card reader making it possible to spy on the code entered by a user on the keypad, unknown to him, or the data of the card inserted in the reader (data of the chip or of the magnetic strip of the card).

This type of attack may in no way, for the user, modify the progress of the transaction, since the sensitive data are spied on electronically, via the fake keypad or the fake card reader attached by an ill-intentioned third party, but they may be processed “normally” in order to make the transaction. This is because, in the case of a fake keypad, the keystrokes made by the user to enter his confidential code are intercepted by the fake keypad but validated all the same by the authentic keypad, the fake keypad making it possible to transfer the mechanical force to the authentic keypad. It is therefore difficult for a user (whether he be experienced or a novice) to ensure that the unattended transaction terminal that he is preparing to use is authentic or not.

Techniques for attempting to prevent the implementation of this type of attack have been developed, for example by modifying the external appearance of the keypad to make it more difficult to stick a fake keypad on it. Some authentic keypads therefore have for example a non-smooth front face (for example with ribs and/or wavelets and/or embossings). Similar techniques may also be used for card readers.

These techniques do however have drawbacks, such as for example an increase in the cost of the authentic keypad/card reader so that they have complex shapes, and the fact that, with the emergence of 3D printers, these complex shapes are becoming more and more easy to reproduce.

Another technique exists in order this time to attempt to detect this type of attack on a card reader, by modifying the colour of the emerging face of the reader. For example, a card reader having a transparent green opening may be identified as probably authentic. On the other hand, since this technique is known, fraudsters may also use fake card readers having a visual appearance very similar to that of “conventional” readers, making it more difficult to detect by a user.

There therefore exists a need for a solution making it possible to respond to the problem of protecting keypads and card readers of unattended transaction terminals against attacks of the type involving the bonding of fake devices on top of the authentic keypads/card readers, while limiting the cost impact on the manufacture of authentic attended transaction payment terminals and not degrading ergonomics for the users.

### SUMMARY

The invention relates to a system for protecting at least one element of an unattended transaction terminal, referred to as the element to be protected, the system comprising:
means for protecting the element or elements to be protected, delivering at least one means of interaction with at least one user of the unattended transaction terminals;
means for detecting an abnormality according to the interaction means.

Thus the invention proposes a novel and inventive solution for interacting with a user of an unattended transaction terminal (for example for paying for a car park or a parking space, a ticket for transport or a show seat, a drink or a snack, etc.), for detecting an abnormality on at least one element to be protected of the unattended transaction terminal, such as for example the keypad or the card reader.

To do this, the invention, according to its various embodiments, makes provision for providing at least one means of interaction with a user, by virtue of protection means used for the element to be protected, and then for taking account of this interaction means for detecting or not an abnormality.

According to a first embodiment of the invention, the protection means comprise:
means for controlling at least one parameter for backlighting of at least part of the element to be protected;
means for emitting at least one signal carrying at least one message, relating to the backlighting parameter, intended to be displayed on a screen of the unattended transaction terminal, the message corresponding to the interaction means,
and the abnormality detection means deliver an alert if no response to the displayed message is received before the expiry of a predetermined time or if a response received to the displayed message is negative.

Thus, this first embodiment makes it possible to interact with a user of an unattended transaction terminal with a view to detecting the presence of a spy element on at least one element to be detected of the terminal, such as for example the keypad or the card reader.

To do this, provision is made, according to this embodiment, to control at least one backlighting parameter of the element to be protected, for example with colour, and then to request the user to confirm, or deny, that he does indeed see the result of this command.

This is because this embodiment is based on the fact that, if a spy element has been stuck or disposed (by an ill-intentioned third party) on the authentic element to be protected, then a modification of the visual appearance of the authentic element cannot be correctly seen by a user.

For example, if a fake keypad has been placed on the authentic keypad of the unattended transaction terminal, a modification to the backlighting colour of the authentic keypad will not be correctly visible to the user, or even not visible at all, the fake keypad completely or partially concealing this change in colour. Likewise, if a fake card reader has been placed on the authentic card reader, then a blinking of the backlighting of the authentic card reader will not be clearly visible to the user.

If the user does not at all, or not distinctly, see the result announced by the message displayed on the screen of the unattended transaction terminal, he can respond negatively to the displayed message, or not respond and abandon the current transaction. In both cases, an alert can be generated, so as to warn (the user or an addressee responsible for maintaining the unattended transaction terminal, etc.) of a risk of fraud on the terminal or to prevent the use of the terminal suspected of being fraudulent.

According to a particular aspect of the invention, the protection system further comprises means for verifying a detected abnormality, comprising the following means:
means for controlling a light source external to the protection system;
means for analysing a light intensity, delivering a decision to validate the detected abnormality if the light intensity analysed is not in accordance with a reference light intensity.

Thus, according to this variant of the first embodiment, when an abnormality has been detected on an unattended transaction terminal, following a non-response or a negative response of a user to a modification of the visual appearance of the keypad or of the card reader, the invention makes provision for being able to check that this anomaly does indeed represent a fraud on the terminal.

For example, this check is carried out by a person responsible for the maintenance of the unattended transaction terminal.

To do this, hardware means are used, such as for example means for detecting an obstruction on top of the keypad or card reader, by detecting a non-conforming light intensity. For example, these means for detecting an obstruction combine firstly a light source, external to the keypad or card reader (and therefore distinct from the internal light sources for backlighting), the illumination of which can be controlled at a distance, and secondly by a brightness sensor, so as to detect that the light intensity received by the sensor does not correspond to the one that it should receive in an authentic configuration. This therefore makes it possible to detect that an element is obstructing the sensor, such as for example a spy element positioned above the element to be protected.

Naturally the location of the brightness sensor must be chosen so as to optimise the detection of an obstruction, taking account also of the ambient light, which may be different depending on the location of the unattended transaction terminal, or the moment when the abnormality check is carried out, or of the power of the external light source.

According to a second embodiment of the invention, the protection means comprise:
means for controlling a light source external to the protection system, a switching on of the external light source corresponding to the interaction means;
means for analysing a light intensity,
and the means for detecting an abnormality deliver an alert if the light intensity analysed is not in accordance with a reference light intensity.

Thus, according to this second embodiment, the invention makes provision for interacting with a user, or more precisely someone maintaining the unattended transaction terminal via means for detecting an obstruction on top of the keypad or card reader, by detecting a non-conforming light intensity.

For example, these obstruction-detection means combine firstly a light source, external to the keypad or to the card reader (and therefore distinct from the internal light sources for backlighting), the switching on of which can be controlled remotely, by the aforementioned user for example, and secondly a brightness sensor, so as to detect that the light intensity received by the sensor does not correspond to what it should receive in an authentic configuration. This therefore makes it possible to detect that an element is obstructing the sensor, for example a spy element positioned on top of the element to be protected.

Naturally the location of the brightness sensor must be chosen so as to optimise the detection of an obstruction, taking account also of the ambient light, which may be different depending on the location of the unattended transaction terminal, or the moment when the abnormality check is carried out, or of the power of the external light source.

For example, an element to be protected is a keypad or a card reader.

Thus the element or elements to be protected of the unattended transaction terminal are the elements via which sensitive and confidential data pass, such as for example the keypad on which a user enters his confidential code or a card reader able to read sensitive data present in the payment card inserted by the user.

This is because these two elements to be protected are the main elements aimed at by attacks by bonding a fake element on top of the authentic element, in a way that is almost undetectable to a user, even a suspicious one.

According to a particular feature of the invention, the protection system comprises means for receiving at least one command for triggering the protection means, coming from a module protecting the unattended transaction terminal.

Thus, according to this variant embodiment, the protection system also comprises means for receiving a command for triggering/activating the protection means proper, so as to implement the invention only when sensitive data are liable to be intercepted by a possible spy element. For example, the protection system receives a command to trigger its means when a user activates the keypad in order to enter a confidential code or when a card is inserted in the card reader, necessarily before the data of the card are read.

In this way, the invention is not implemented when no activity is detected on the unattended transaction terminal, so as not to unnecessarily modify the behaviour of the terminal.

In addition, this makes it possible not to alert the malevolent person, so that he does not adjust his system.

For example, the means for receiving a triggering command and/or the protection means are implemented in the element to be protected.

Thus the invention does not require a specific hardware or software module but uses means already present in one of the elements to be protected of the unattended transaction terminal, for example in the keypad.

This is because it is currently usual for the keypad to comprise software and hardware means corresponding to “intelligence”, that is to say making it possible for example to transmit messages to the man-machine interface of the unattended transaction terminal, to process messages received coming from the man-machine interface, to receive commands, for example in order to activate components of the keypad, etc.

According to a particular aspect, the means for controlling at least one backlighting parameter belong to the group comprising:
means for activating one or more colours emitted by at least one light source internal to at least one element to be protected;
means for the intermittent activation of at least one light source internal to the element to be protected;
a combination of the activation means.

Thus the invention, according to its various variants of the first embodiment, makes it possible to control an external visual appearance of the element to be protected (the keypad or the card reader) so as to enable a user to react if the expected result of this control does not appear to him explicitly, which will mean that a spy element is probably installed on top of the keypad/card reader.

For example, the “overall” colour of the element to be protected may be changed compared with the “conventional” colour, choosing a different colour for all the light sources (for example the backlighting LEDs of the keypad or card reader) or using multicolour LEDs making it possible to choose the colour to be emitted, for example randomly in order to make ill-intentioned reproduction of the behaviour of the protected element more complex. The message displayed simultaneously on the screen of the unattended transaction terminal may consist for example of asking the user whether the keypad/card reader does indeed appear in the specific colour chosen.

According to another variant, only the colour of part of the element to be protected may be changed with respect to the “conventional” colour, choosing a different colour for only some of the light sources (for example the backlighting LEDs of some keys of the keypad, or only of the “circumference” of the keypad, or the backlighting LEDs of the bottom part of the card reader, etc.).

According to yet another variant, the control consists of activating intermittently one or more backlighting LEDs of the keypad/card reader in order to obtain a blinking. This variant makes it possible for example to take account of any visual defect in the user (colour blindness), who would not see the colours correctly but might see blinking without any problem.

Finally, it is of course possible to combine these various embodiments, so as to choose not only the colour, globally or partially, of the element to be protected, but also to obtain blinking of this colour.

According to a particular feature of the invention, the protection system comprises means for backlighting at least part of the element to be protected, the backlighting means belonging to the group comprising:
a light guide around at least part of the element to be protected;
a structure composed of a plastic part, connected to at least one light source internal to at least one element to be protected, placed on an impact-resistant white part;
a structure composed of a light-diffusing part, connected to at least one light source internal to the element to be protected, a light-diffusing frosted film and an impact-resistant protective part;
a light source disposed under at least one key of the element to be protected, when the latter is a keypad.

Thus the invention, according to its various variants of the first embodiment, comprises specific backlighting means for implementing the protection means and in particular control of the backlighting parameters described above.

A plurality of different variants of the backlighting means can be implemented, and existing means can in particular be used, such as for example light guides conventionally used for backlighting a keypad or a card reader. This also makes it possible to limit the structural modifications to be made on the device to be protected.

Moreover, very precise means can be used, so as to reinforce the protection, such as for example separate lighting for each key on the keypad, the colour of which may for example be different.

For example, the alert belongs to the group comprising:
an alert message displayed, for the user, on the screen of the electronic payment terminal;
an alert message transmitted to a predefined addressee, for example a maintenance person;
a combination of the above alerts.

The invention also relates to a method for protecting at least one element of an unattended transaction terminal, referred to as the element to be protected, comprising:
a step of protecting the element to be protected, delivering at least one means of interaction with at least one user of the unattended transaction terminal;
a step of detecting an abnormality according to the interaction means.

The invention also relates to a computer program product, comprising program code instructions for implementing a method as described previously, when the program is executed on a computer.

The invention also relates to a storage medium that can be read by a computer and is non-transient, storing a computer program product as described above.

### FIGURES

Other features and advantages will emerge more clearly from a reading of the following description of a particular embodiment of the disclosure, given by way of simple illustrative and non-limitative example, and the accompanying drawings, among which:

FIGS. 1a to 1c illustrate respectively an example of a protection system according to the general principle of the invention and two embodiments;

FIGS. 2a to 2d illustrate four variant embodiments of the backlighting means of a protection system as illustrated in FIG. 1;

FIG. 3 illustrates the main steps of a protection method according to an embodiment of the invention.

On all the figures of the present document, identical elements and steps are designated by the same reference.

### DESCRIPTION

### 1. General Principle

The general principle of the technique described consists of modifying a visual appearance of an element to be protected of an unattended transaction terminal and trigging an interaction, in connection with the modification made, with a user of this terminal in order to detect any possible abnormality on this element to be protected, such as for example the keypad or the chip card reader.

Thus the solution of the invention, according to the various embodiments thereof, makes it possible to detect any possible fraud on an element of an unattended transaction terminal, a fraud that is difficult to detect by a user (in particular for an inexperienced user) without specific means, by directly involving the user of the terminal via interaction means.

Hereinafter, for easier reading, examples of protection of an element to be protected of an unattended transaction terminal will be described, but naturally a plurality of elements (for example the keypad and the card reader) may be protected at the same time in the same unattended transaction terminal.

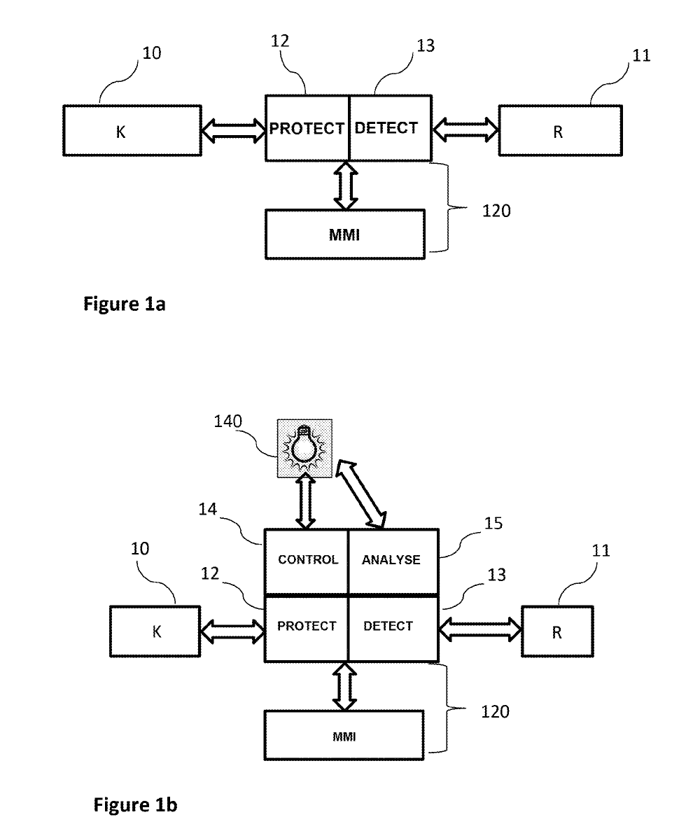

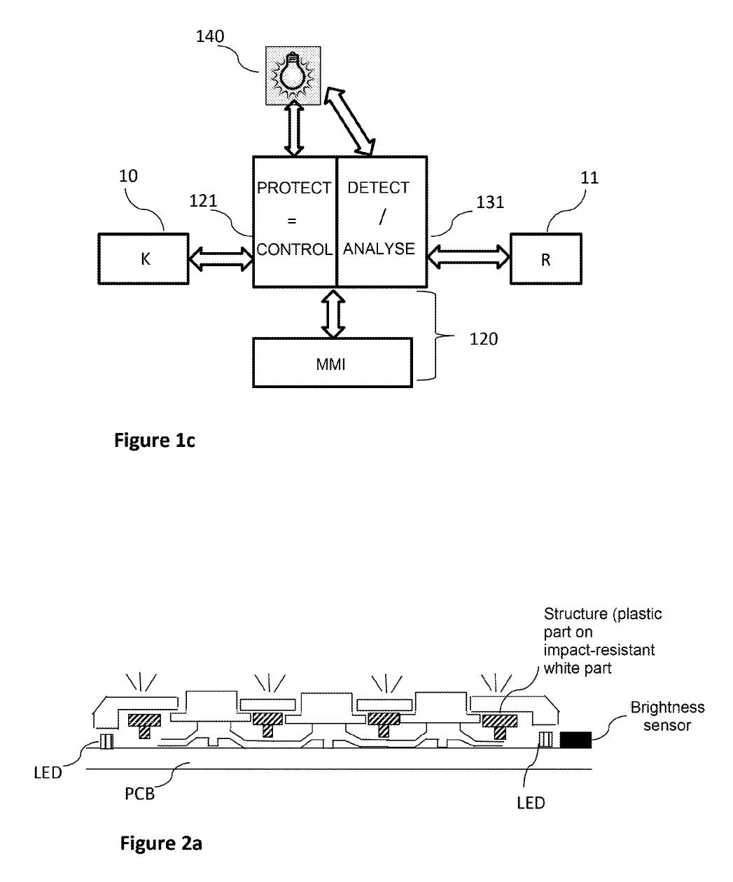

For example, and as illustrated in FIG. 1a, an element to be protected of an unattended transaction terminal is the keypad K (10) or the card reader R (11). This is because these two elements frequently suffer attempts at pirating or fraud, because they enable sensitive data to pass in order to perform a banking transaction (for example a confidential code entered on the keypad or data of the chip card/magnetic swipe card inserted in the card reader). As already indicated in relation to the prior art, one of the attacks most frequently observed on these elements consists of sticking on a fake element, very difficult to detect by a user, so as to spy on the sensitive data that pass, without preventing the conventional functioning of the unattended transaction terminal, and therefore without alerting the end user.

Conventionally, an unattended transaction terminal also comprises a man-machine interface MMI making it possible, via a screen, to interact with a user (for example in order to display card-insertion or code-entry instructions, or to display withdrawal amounts or choices of possible actions).

Moreover, the protection system of the present invention, according to the various embodiments thereof, comprises firstly protection means 12 capable of visually modifying an appearance of the unattended transaction terminal, and to interact with the user of the terminal via an interaction means 120, and secondly means 13 for detecting an abnormality, according to the interaction with the user.

These various means are described in further detail below, in relation to various embodiments of the invention.

### 2. Description of a First Embodiment

### 2.1. Protection

An example of a system for protecting at least one element of an unattended transaction terminal is now presented, in relation to FIG. 1a, according to a first embodiment of the invention.

According to this first embodiment of the invention, the protection means (12) of the protection system comprise:
firstly, means for controlling at least one backlighting parameter of the element to be protected, so as to modify the visual appearance of the element to be protected,
secondly, means for emitting a signal carrying a message related to this backlighting parameter and intended to be displayed on a screen of the unattended transaction terminal, so as to invite the user to confirm that he has indeed viewed the modification of the visual appearance of the element to be protected.

Thus the protection system according to this embodiment of the invention makes it possible to detect any abnormality, in the case where the response of the user does not correspond to a response expected in a normal situation. For example, if the user does not confirm that he sees the modification, or does not reply to the request for interaction, the protection system detects a possible abnormality.

Moreover, the control means allowing modification of the visual appearance of the element to be protected are for example:
means for activating a colour emitted by at least one light source internal to the element to be protected, so as to change the colour of all or part of the element to be protected, according to the location of the light source or sources (around the keypad, under each key of the keypad, around the card reader insertion slot, etc.), and/or
means for the intermittent activation of at least one light source internal to said at least one element to be protected, so as to make one or more light sources internal to the element to be protected blink.

A combination of these activation means may be used, for example by making one or more light sources blink while changing the colour. The means used in relation to these light sources are described in more detail below.

Moreover, the interaction implemented with the user is for example the display of a message on the screen of the unattended transaction terminal, via the MMI, seeking a response from the user. This message must of course be adapted to the modification made to the visual appearance of the element to be protected, so that the response of the user is consistent. This message is displayed simultaneously with the modification made to the visual appearance, in order to make it more difficult for this behaviour to be reproduced by an ill-intentioned third party.

Thus, if the modification consists for example of backlighting the keypad in blue, whereas it is conventionally backlit in white, the message may be worded as follows:

“Please confirm that the keypad now appears in blue, by pressing the OK key.

Otherwise press the CANCEL key”.

If the modification consists of making the backlighting of the card reader insertion slot blink, without modifying its colour, the message may be worded as follows:

“Please confirm that the card insertion slot is blinking, by pressing the OK key.

Otherwise press the CANCEL key”.

This message may be preceded by another message consisting of an announcement relating to the security of the unattended transaction terminal being used, informing the user that a simple and rapid abnormality-detection procedure will follow, seeking a response on his part.

The user is therefore led to enter a response, via the keypad. This response, or the absence of a response at the expiry of a predetermined period, is processed by the abnormality detection means 13 in order to deduce therefrom or not the presence of an abnormality.

According to the message examples above, if the user presses the OK key, the detection means 13 analyse this response as an absence of an abnormality and the transaction continues normally, the user also being reassured as to the authenticity of the sensitive elements of the unattended transaction terminal that he is using.

On the other hand, if the user presses the CANCEL key, the detection means 13 analyse this response as a detection of an abnormality and for example deliver an alert. Likewise, if the user, made mistrustful by the fact that he does not see the colour and/or blinking announced, prefers not to continue by not responding to the displayed message, the detection means 13 treat this absence of a response as a detection of abnormality and deliver for example an alert. Conventionally, an absence of a response is considered to be confirmed only at the expiry of a predetermined period, giving the user time to interact. During this period, the visual appearance modified by the protection means is maintained (the blinking continues for example, or the modified colour is still displayed).

Such an alert may take several forms, combining for example information intended for the user and/or a manager (or person responsible for maintenance) of the unattended transaction terminal and protecting the terminal suspected of attack.

Thus the alert may consist of displaying a new message on the screen of the unattended transaction terminal, informing the user of a potential fraud and recommending him no longer to use the terminal.

Moreover, an alert may also be sent to a pre-identified addressee, such as for example a manager responsible for the maintenance of the unattended transaction terminal. This manager can then check whether the abnormality detected is confirmed, by going to the site. This check may also be implemented by virtue of checking means described in more detail below (section 2.3), in relation to this first embodiment of the invention.

Moreover, the implementation of such protection of an element of an unattended transaction terminal is in principle necessary only when the terminal is being used, that is to say when a transaction is initiated for example.

Thus the protection system of the invention, according to this embodiment, also comprises means for receiving at least one command triggering the protection means, coming from a module for protecting said unattended transaction terminal.

For example, the protection module, which may be situated in the element to be protected itself, or more generally in the unattended transaction terminal, detects that this element to be protected is activated (for example when a card is inserted in the card reader, or when a confidential code is required by entry via the keypad) and then transmits a command to the protection system in order to trigger the protection means.

Thus the modifications made to the visual appearance of one or more elements to be protected of an unattended transaction terminal are actually made only when the terminal is being used and it is necessary to check the absence of fraud.

According to a variant usage, this command triggering the protection may also be sent at the request of a manager or maintenance person, wishing to make checks on the authenticity of one or more unattended transaction terminals at the same time, for example when going to a site where a plurality of terminals are present. In such a situation, the maintenance person may trigger the protection of a plurality of terminals at the same time, for example by causing to blink, or by choosing a non-conventional colour for the backlighting of all the keypads of the terminals around him (this may for example be a configuration in a railway station where a plurality of train ticket dispensers are situated) and/or all the card readers of these terminals. Thus the maintenance person is capable of having a global vision of the set of unattended transaction terminals and, if one or more are not blinking, or if one or more remain backlit with a conventional colour, then he can move closer in order to check whether a fraud is confirmed.

### 2.2. Backlighting Means

The backlighting means used according to this first embodiment of the invention to modify the visual appearance of the element to be protected are now described in more detail.

It should be noted that, when backlighting means already exist, for example in the form of light sources (such as LEDs) associated with one or more light guides, these means may be used for implementing the present invention, in order to optimise costs.

The existing means may nevertheless be adapted, for example by replacing the white LEDs conventionally used with colour LEDs. In addition, adaptations are also necessary for implementing the checking means described below.

When no backlighting means is already present on the element to be protected, the invention, according to this embodiment, makes provision for adding one.

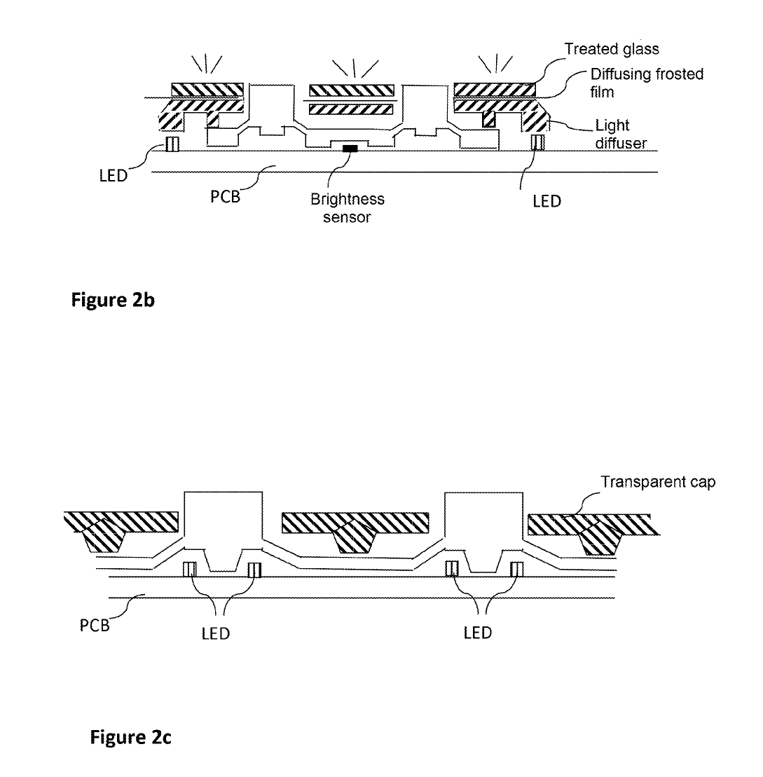

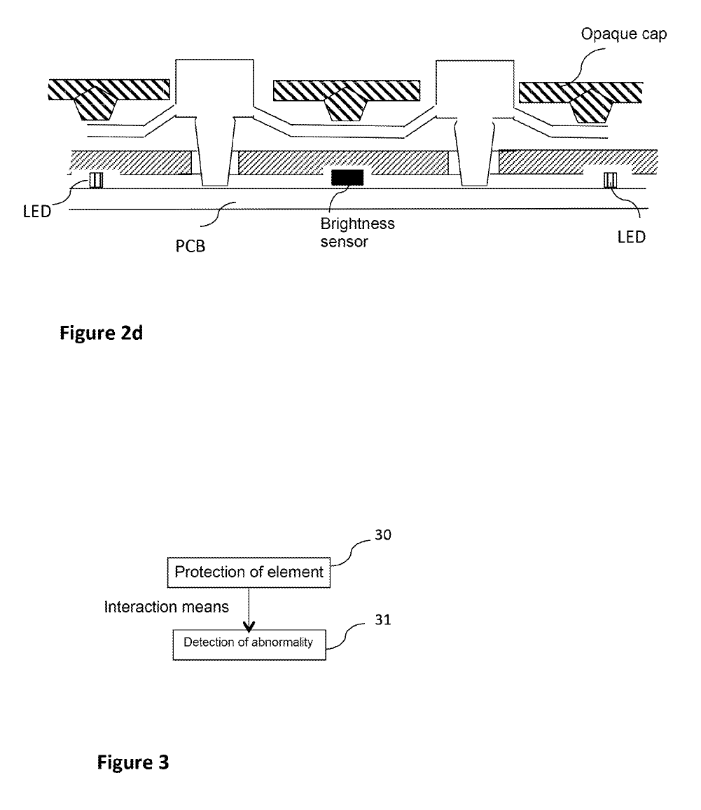

These backlighting means may therefore be implemented in varied forms, such as for example:
a light guide around at least part of the element to be protected: for example a light guide framing the keypad or card reader, and backlighting the element to be protected in the form of four light lines. The light sources providing backlighting may be of identical or different colours;
in the case where the element to be protected is the keypad:
   a structure composed of a plastic part, connected to at least one light source internal to the keypad, placed on an impact-resistant or white part, as illustrated in FIG. 2a. Such a configuration is relatively conventional and may be modified for the invention by replacing the white LEDs with colour LEDs;
   a structure composed of a light-diffusing part, connected to the at least one light source internal to the keypad, a light-diffusing frosted film and an impact-resistant protective part (made from glass for example), as illustrated in FIG. 2b. Such a configuration in some way corresponds to a glass keypad, illuminated from behind by a luminous part;
   a light source disposed under at least one key of the keypad, or under each key, thus making it possible to individually illuminate a plurality of keys of the keypad with different colours, as illustrated in FIGS. 2c and 2d. Thus, according to a first variant illustrated in FIG. 2c, the keypad is very simple, and has one LED per key, controllable separately, and not requiring a light guide; a brightness sensor may be positioned alongside each key (for detecting an obstruction already described above, provided that the LED is switched off when the obstruction is detected, so as not to dazzle the sensor). According to a second variant illustrated in FIG. 2d, a reduced number of LEDs (for example 2 or 4) are used, and the light is guided, via a light guide, vertically to the keys; a brightness sensor must therefore be carefully positioned in order to be sufficiently illuminated by the external lighting.

Thus, according to the implementation chosen for the backlighting means, it is possible to modify and/or to make blink the colour of a light guide framing the keypad and/or the card reader, to modify and/or to make blink the overall colour of the backlighting of a keypad, or to modify and/or make blink independently the colour of a plurality of keys of a keypad.

The interaction messages intended for the user are then adapted to the modification of the visual appearance actually used.

### 2.3. Check

The invention, according to this embodiment, also provides checking means for checking whether the abnormality detected is confirmed, by detecting an obstruction synonymous with the presence of a spy element stuck on top of the element to be protected (for example a fake keypad).

To do this, the means for verifying a detected anomaly comprise, according to this first embodiment, the following means:
means 14 for controlling/driving a light source 140 external to the protection system, making it possible to remotely control the switching on, switching off and/or blinking of an external light source, the light intensity of which is known and corresponds to a reference light intensity, when it is switched on;
means 15 for analysing a light intensity, delivering a decision to validate the detected abnormality if the light intensity analysed is not in accordance with a reference light intensity. For example, it is a brightness sensor, judiciously placed to detect the reference intensity of the external light source in normal operation and to detect an obstruction synonymous with fraud when a spy element is ill-intentionally positioned on top of the element to be protected.

These verification means may be activated for example by the person maintaining the unattended transaction terminal, warned by the alert emitted at the moment of detection of an abnormality. In this way, the maintenance person can check this abnormality remotely without going to the site where the terminal is situated. He can thus reinforce the protection actions of the unattended transaction terminal possibly already implemented, putting the terminal “out of service”, before travelling to confirm the fault and establish corrective actions (dismantling of the spy element for example).

### 3. Description of a Second Embodiment

This second embodiment implements in fact protection corresponding to the verification described above, the protection therefore consisting of detecting an obstruction synonymous with the presence of a spy element bonded on top of the element to be protected (for example a fake keypad).

More precisely, according to this second embodiment illustrated in FIG. 1c, the protection means 12 comprise:
means 121 for controlling/driving a light source 140 external to the protection system, switching on the external light source corresponding to the interaction means. Thus the interaction with the user consists of switching on the external light source (and not responding to a message displayed on the screen of the unattended transaction terminal, as in the first embodiment);
means 131 for analysing a light intensity. For example it is a brightness sensor, judiciously placed to detect the reference intensity of the external light source in normal operation and to detect an obstruction synonymous with fraud when a spy element is ill-intentionally positioned on top of the element to be protected.

In addition, according to this second embodiment, the means for detecting an abnormality deliver an alert if the light intensity analysed is not in accordance with a reference light intensity.

Thus this second embodiment is more particularly suited in the case of the maintenance of an unattended transaction terminal in a set of unattended transaction terminals, when the maintenance person wishes, before going on site, to carry out a first check on the authenticity of the terminals in the set. This is because, in such a context, the maintenance person can remotely control the switching on of each external light source provided on each unattended transaction terminal and detect any obstruction via the brightness sensor placed inside each element to be protected or each terminal.

### 4. Protection Method

The invention also relates to a method for protecting at least one element of an unattended transaction terminal, referred to as the element to be protected, as illustrated in FIG. 3.

According to this embodiment of the invention, the method comprises a step 30 of protecting at least one element to be protected (the keypad and/or the card reader), delivering at least one means 120 for interacting with the user of the unattended transaction terminal.

As already described above in relation to the two embodiments of the invention, the interaction means may consist of a message displayed on the screen of the terminal (first embodiment) to which the user must respond in accordance with his observation of the behaviour of the terminal, or may consist of switching on the external light source (second embodiment).

A step 31 of detecting an abnormality is next implemented, according to the interaction means, as described above in relation to the two embodiments of the invention.

The protection method, according to the various embodiments of the invention, can be implemented in an unattended transaction terminal, and more particularly in the element to be protected itself (for example the keypad or the card reader).

1. A system for protecting at least one element of an unattended transaction terminal, referred to as the element to be protected, wherein said system comprises:
means for protecting said at least one element to be protected, delivering at least one means of interaction with at least one user of said unattended transaction terminal; and
means for detecting an abnormality according to said at least one means of interaction.

2. The system according to claim 1, wherein said protection means comprise:
means for controlling at least one parameter for backlighting of at least part of said at least one element to be protected;
means for emitting at least one signal carrying at least one message, relating to said backlighting parameter, intended to be displayed on a screen of said unattended transaction terminal, said at least one message corresponding to said at least one interaction means,
and said means for detecting an abnormality deliver an alert if no response to said displayed message is received before the expiry of a predetermined time or if a response received to said displayed message is negative.

3. The system according to claim 2, further comprising means for checking a detected abnormality, comprising:
means for controlling a light source external to said protection system;
means for analysing a light intensity, delivering a decision to validate said detected abnormality if said light intensity analysed is not in accordance with a reference light intensity.

4. The system according to claim 1, wherein said means for protecting comprise:
means for controlling a light source external to said protection system, a switching on of said external light source corresponding to said interaction means;
means for analysing a light intensity,
and said means for detecting an abnormality deliver an alert if the light intensity analysed is not in accordance with a reference light intensity.

5. The system according to claim 1, wherein said at least one element to be protected is a keypad or a card reader.

6. The system according to claim 1, comprising means for receiving at least one triggering command to trigger said means for protecting, coming from a module for protecting said unattended transaction terminal.

7. The system according to claim 6, wherein said means for receiving a triggering command and/or said means for protecting are implemented in said at least one element to be protected.

8. The system according to claim 2, wherein said means for controlling at least one backlighting parameter belong to the group consisting of:
means for activating one or more colours emitted by at least one light source internal to said at least one element to be protected;
means for intermittent activation of at least one light source internal to said at least one element to be protected;
a combination of said means for activating and said means for intermittent activation.

9. The system according to claim 1, comprising means for backlighting at least part of said at least one element to be protected, said means for backlighting belonging to the group consisting of:
a light guide around at least part of said element to be protected;
a structure composed of a plastic part, connected to at least one light source internal to said at least one element to be protected, placed on an impact-resistant white part;
a structure composed of a light-diffusing part, connected to at least one light source internal to said at least one element to be protected, a light-diffusing frosted film and an impact-resistant protective part;
a light source disposed under at least one key of said element to be protected, when the latter is a keypad.

10. A method for protecting at least one element of an unattended transaction terminal, referred to as the element to be protected, wherein said method comprises:
protecting said at least one element to be protected, delivering at least one interaction with at least one user of said unattended transaction terminal;
detecting an abnormality according to said at least one interaction.

11. (canceled)

12. A computer-readable and non transitory storage medium, storing a computer program product thereon, which when executed by a processor of a protection system configure the protection system to perform acts comprising:
protecting at least one element of an unattended transaction terminal, referred to as the element to be protected, wherein protecting comprises:
protecting said at least one element to be protected, delivering at least interaction with at
least one user of said unattended transaction terminal;
detecting an abnormality according to said interaction.
